(19) United States
(12) Patent Application Publication
(10) Pub. No.: US 2007/0171773 A1
(43) Pub. Date: Jul. 26, 2007

(54) Optical disc and optical disc recording/reproducing device technical field

(75) Inventor: Yorio Takahashi, Ehime (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd, Osaka (JP)

(21) Appl. No.: 10/589,917

(22) PCT Filed: Apr. 25, 2005
(86) PCT No.: PCT/JP05/07776

§ 371 Date: Aug. 18, 2006

(30) Foreign Application Priority Data
Apr. 27, 2004 (JP) 2004-130556

(51) Int. Cl. G11B 7/085; G11B 21/08

(52) U.S. Cl. 369/30.03

(57) ABSTRACT

An optical disc wherein recording can be performed on a label plane even only by an optical disc recording/reproducing device using a direct-current motor as a power supply of an optical pickup in a traverse direction. The optical disc is provided with a visible information recording layer (207), which can record visible information by changing a physical structure by irradiation light of the optical pickup, and a radius position information recording part (201). Therefore, even when an optical disc recording/reproducing device using a direct-current motor as a power supply of the optical pickup in the traverse direction, the contents of the radius position information recording part (201) are read and recorded on the label plane only by the device.

### TECHNICAL FIELD

The present invention relates to an optical disc capable of forming visible information such as characters and images on a reverse plane (generally referred to as “label plane”) of an information recording plane thereof with the use of a laser beam from an optical disc recording/reproducing device.

### BACKGROUND ART

Disclosed in JP2003-203348A is an optical disc of this type. In this optical disc, a thermal layer having a characteristic of sensing heat to thereby produce color is formed on a label plane as a reverse plane of an information recording plane on which digital information is recorded as a pit. In the case of writing the visible information to the label plane, the optical disc is set to a spindle motor of an optical disc recording/reproducing device so that the label plane of the optical disc faces an optical pickup of the optical disc recording/reproducing device. Then, while the optical disc is rotationally driven at a constant angular velocity (CAV control), images of target visible information are supplied to the optical pickup in synchronization with this rotation.

The optical pickup includes a laser diode. In the case of accessing the information recording plane of the optical disc to record digital information, the laser diode has an output power controlled so as to enable to emit a laser beam larger than that in the case of reading out the digital information already recorded on the information recording plane. Also in the case of writing the visible information to the label plane, the laser diode modulates an output power similar to that in the case of writing the digital information to the information recording plane to emit a laser beam, and allows the thermal layer to produce color to thereby record target images.

In the case of writing images to the label plane, the optical pickup is moved in a radial direction (traverse direction) of the optical disc and the target images are developed on the label plane for recording. As for the conventional control of the optical pickup in the traverse direction, the aforementioned publication discloses that positions in the radial direction differently at different times are determined by the number of driving pulses transmitted to a stepping motor.

With this configuration, it is possible to write images to the label plane without using a printer device prepared separately from the optical disc recording/reproducing device.

In order to drive the optical pickup in the traverse direction in the conventional optical disc recording/reproducing device, a direct-current motor is used in place of the stepping motor disclosed in the aforementioned publication in some cases, as disclosed in JP2000-339719A.

According to an optical disc recording/reproducing device using a direct-current motor as a power supply in a traverse direction, in the case of writing digital information to the information recording plane, track information recorded on the recording plane of the optical disc is read by an optical pickup, the direct-current motor is energized until detection of track information of a target value while the number of traversing tracks is counted, and the optical pickup is controlled so as to move to a target position.

### DISCLOSURE OF THE INVENTION

Problem to be Solved by the Invention

As disclosed in JP2003-203348A, the device using the stepping motor can control a radius position by a feed amount of the stepping motor itself. On the other hand, in the optical disc recording/reproducing device using the direct-current motor as a power supply of the optical pickup in the traverse direction, even when the optical disc is set in such a manner that the label plane thereof faces the optical pickup for the purpose of writing images to the label plane without using the separately prepared printer device, the direct-current motor cannot grasp an accurate movement amount, and track information required to control the driving of the optical pickup in the traverse direction cannot be obtained because the label plane has no track. Consequently, it is impossible to record information on the label plane only by the optical disc recording/reproducing device under present circumstances.

The present invention aims to provide an optical disc wherein recording can be performed on a label plane even only by an optical disc recording/reproducing device using a direct-current motor as a power supply of an optical pickup in a traverse direction.

Means for Solving the Problem

An optical disc according to one aspect of the present invention has a digital information recording plane capable of recording or reproducing digital information there on or therefrom. The optical disc comprises: a visible information recording layer that is formed on a reverse plane of the digital information recording plane, and can record visible information by a change in physical structure with irradiation of light from an optical pickup; and a radius position information recording part that is formed on the reverse plane of the digital information recording plane by dividing the optical disc into certain regions at a radius position, and records different radius position information on each divided certain region at the radius position having a reflectivity different from that of the visible information recording layer.

An optical disc according to another aspect of the present invention has an information recording plane capable of recording or reproducing information thereon or therefrom. The optical disc comprises: a visible information recording layer that is formed on a reverse plane of the information recording plane, and can record visible information by a change in physical structure with irradiation of light from an optical pickup; a radius position information recording part that is formed on the reverse plane of the information recording plane by dividing the optical disc into certain regions at a radius position and records different radius position information on each divided certain region having a reflectivity different from that of the visible information recording layer; and a radius position information division region that is provided between two pieces of radius position information adjacent to each other in the radius direction of the radius position information recording part to distinguish the radius position information on an inner peripheral side from the radius position information on an outer peripheral side.

An optical disc according to still another aspect of the present invention is an information disc having an information layer capable of recording or reproducing information on or from an information track. The information disc comprises, on a reverse plane of the information plane thereof: a visible information recording layer that can record visible information by a change in physical structure with irradiation of light at a certain level or more; and a radius position information recording part that divides the information disc into certain ranges at a radius position, and previously records different radius position information on each divided certain range at the radius position having a reflectivity different from that of the visible information recording layer by means of a combination of radial stripe patterns each corresponding with a certain rotation angle. The stripe patterns include headers with fixed length and fixed pattern and radius position information main bodies with fixed length that are alternately and sequentially recorded plural times in such a manner that the radius position information main body is interposed between the headers. The optical disc is capable of reading the information of the radius position information recording region to thereby control the radius position of the optical pickup and record visible information, and is capable of adopting, as effective radius position information, only radius position information of a radius position information main body interposed between pieces of information of effective headers to thereby avoid erroneous detection upon occurrence of traverse between pieces of radius position information due to eccentricity.

An optical disc recording/reproducing device according to one aspect of the present invention has a spindle motor to which the optical disc is set in such a manner that the visible information recording plane faces an optical pickup and writing visible information to the visible information recording layer while moving the optical pickup in a radius direction. The optical disc recording/reproducing device comprises: a radius position information detection section for reading the radius position information recording part formed on the visible information recording plane of the optical disc with the use of the optical pickup to thereby detect an existing position of the optical disc at the radius position; and a visible information recording control section for reading out data of visible information to be written to the visible information recording layer in accordance with the detected existing position and controlling the power of a laser beam applied from the optical pickup to the visible information recording layer, thereby writing visible information.

An optical disc recording/reproducing device according to another aspect of the present invention has a spindle motor to which the optical disc is set in such a manner that the visible information recording plane faces an optical pickup and writing visible information to the visible information recording layer while moving the optical pickup in a radius direction. The optical disc recording/reproducing device comprises: a radius position information division region passage detection section for detecting passage of the radius position information division region on the basis of contents read by the optical pickup; a radius position information detection section for detecting an existing position of the optical pickup at the radius position of the optical disc on the basis of contents obtained when the radius position information division region passage detection section does not pass the radius position information division region; and a visible information recording control section for reading out data of visible information to be written to the visible information recording layer in accordance with the detected existing position and controlling the power of a laser beam applied from the optical pickup to the visible information recording layer, thereby writing visible information.

An optical disc recording/reproducing device according to still another aspect of the present invention has a spindle motor to which the optical disc is set in such a manner that the visible information recording plane faces an optical pickup and writing visible information to the visible information recording layer while moving the optical pickup in a radius direction. The optical disc recording/reproducing device comprises: a radius position information division region passage detection section for detecting passage of the radius position information division region on the basis of contents obtained when the optical pickup reads the radius position information recording part; a radius position information detection section for detecting an existing position of the optical pickup at the radius position of the optical disc on the basis of contents obtained when the radius position information division region passage detection section does not pass the radius position information division region; a header detection section for detecting a header with fixed length and fixed pattern on the basis of an output from the radius position information detection section; a radius position information detection section for detecting the header with fixed length and fixed pattern upon passage of no radius position information division region to thereby detect radius position information on the basis of the reading result of the radius position information detection section and the detection result of the radius position information division region passage detection section; and a visible information recording control section for reading out data of visible information to be written to the visible information recording layer in accordance with the detected existing position and controlling the power of a laserbeam applied from the optical pickup to the visible information recording layer, thereby writing visible information.

An optical disc recording method according to one aspect of the present invention is used when the optical disc is set to a spindle motor so that the visible information recording plane faces an optical pickup, and visible information is written to the visible information recording layer while the optical pickup is moved in a radius direction. The optical disc recording method comprises: detecting passage of the radius position information division region on the basis of contents read by the optical pickup and, also, detecting an existing position of the optical pickup at the radius position of the optical disc on the basis of contents obtained when the radius position information division region is not passed; and reading out data of visible information to be written to the visible information recording layer in accordance with the detected existing position and controlling the power of a laser beam applied from the optical pickup to the visible information recording layer, thereby writing visible information.

An optical disc recording method according to another aspect of the present invention is used when the optical disc is set to a spindle motor so that the visible information recording plane faces an optical pickup, and visible information is written to the visible information recording layer while the optical pickup is moved in a radius direction. The optical disc recording method comprises: detecting whether or not the radius position information division region is passed, on the basis of contents obtained when the optical pickup reads the radius position information recording part; detecting an existing position of the optical pickup at the radius position of the optical disc, on the basis of contents obtained when the radius position information division region is not passed; detecting a header with fixed length and fixed pattern on the basis of an output from the radius position information detection section;detecting the header with fixed length and fixed pattern obtained when the radius position information division region is not passed to thereby detect radius position information, on the basis of a reading result of the radius position information detection section and a detection result of the radius position information division region passage detection section; and reading out data of visible information to be written to the visible information recording layer in accordance with the detected existing position and controlling the power of a laser beam applied from the optical pickup to the visible information recording layer, thereby writing visible information.

### EFFECT OF THE INVENTION

According to the present invention, an optical disc is provided with a visible information recording layer capable of recording record visible information by a change in physical structure with irradiation of light from an optical pickup, and a radius position information recording part. Therefore, recording can be performed on a label plane even only by an optical disc recording/reproducing device using a direct-current motor as a power supply of the optical pickup in a traverse direction.

### BRIEF DESCRIPTION OF THE DRAWINGS

FIG. 1A is an external perspective view of an optical disc according to Embodiment 1 of the present invention;

FIG. 1B is a sectional view of the optical disc according to Embodiment 1 of the present invention;

FIG. 1C is an enlarged view of a main part of the optical disc according to Embodiment 1 of the present invention;

FIG. 2 is a configuration diagram of an optical disc recording/reproducing device for writing visible information to the optical disc according to Embodiment 1 of the present invention;

FIG. 3 is a signal waveform chart of a main part illustrated in FIG. 2;

FIG. 4 is a sectional view illustrating another structure of the optical disc according to Embodiment 1 of the present invention;

FIG. 5A is a sectional view illustrating still another structure of the optical disc according to Embodiment 1 of the present invention;

FIG. 5B is a sectional view illustrating yet another structure of the optical disc according to Embodiment 1 of the present invention;

FIG. 6A is a sectional view illustrating yet another structure of the optical disc according to Embodiment 1 of the present invention;

FIG. 6B is a sectional view illustrating yet another structure of the optical disc according to Embodiment 1 of the present invention;

FIG. 7A is a sectional view of an optical disc according to Embodiment 2 of the present invention;

FIG. 7B is a sectional view of the optical disc according to Embodiment 2 of the present invention;

FIG. 8 is an illustration of a radius position information recording part of an optical disc according to Embodiment 3 of the present invention;

FIG. 9 is an illustration of a radius position information recording part of an optical disc according to Embodiment 4 of the present invention;

FIG. 10 is an illustration of a specific example of Embodiment 4 of the present invention;

FIG. 11 is an illustration of a specific example of Embodiment 4 of the present invention; and

FIG. 12 is an illustration of a specific example of Embodiment 4 of the present invention.

### BEST MODE FOR CARRYING OUT THE INVENTION

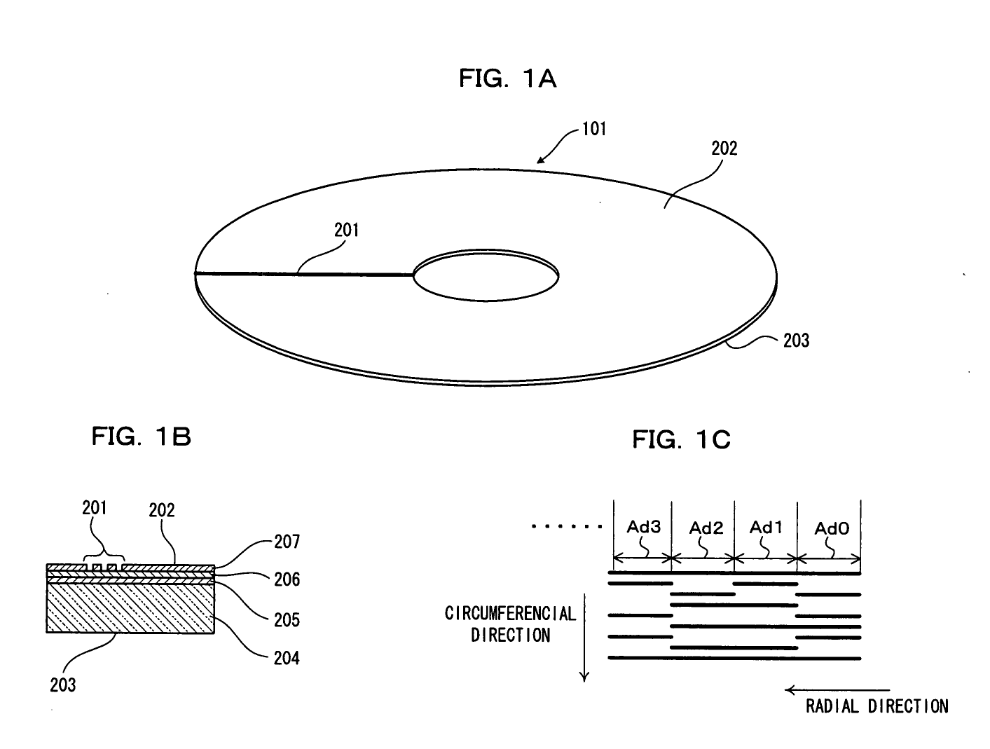

Hereinafter, description will be given of embodiments of the present invention with reference to FIGS. 1 to 12.

### EMBODIMENT 1

FIGS. 1A, 1B and 1C illustrate an optical disc 101 according to the present invention. Herein, description will be given of, as an example, an optical disc based on CD-ROM standards.

In the optical disc 101, as illustrated in FIG. 1B, a digital information recording plane 203 including a recording layer 205 and a transparent substrate 204 is formed under a reflection layer 206. On a side opposite to the digital information recording plane 203, a visible information recording plane 202 including a visible information recording layer 207 and a radius position information recording part 201 is formed on the reflection layer 206.

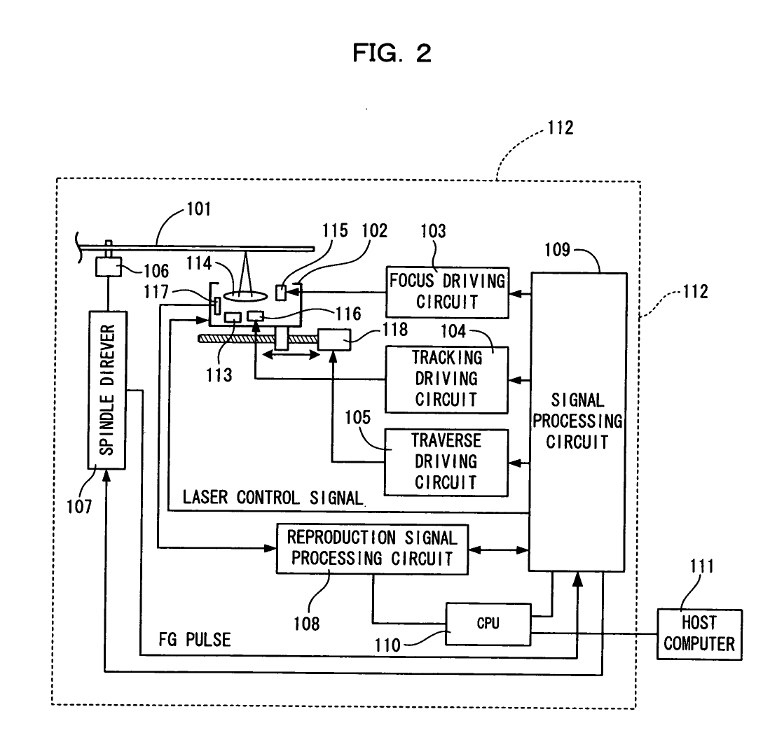

In order to use the optical disc 101, the optical disc 101 is set to a spindle motor 106 so that the digital information recording plane 203 or the visible information recording plane 202 faces an optical pickup 102 of an optical disc recording/reproducing device illustrated in FIG. 2.

In the case of the optical disc 101 based on CD-ROM standards, the recording layer 205 is formed with a pit in a spiral shape. The optical disc recording/reproducing device irradiates this pit with a laser beam emitted from the optical pickup 102 to trace the pit, thereby obtaining a reproduction signal.

The visible information recording layer 207 takes a form of a thermal layer that causes a physical change by sensing heat, thereby producing color. The visible information recording layer 207 causes a physical change by a laser beam of a certain level or more emitted from the optical pickup 102 to thereby record visible information. The visible information recording layer 207 has no track and is structured only by being laminated on the reflection layer 206.

As illustrated in FIG. 1C as an enlarged schematic view of a radius position of the optical disc 101, the radius position information recording part 201 is divided into plural regions of a 0th region Ad0, a first region Ad1, a second region Ad2, a third region Ad3, . . . from an inner peripheral edge toward an outer peripheral edge. In each region, radial stripe patterns different from one another for each region and each corresponding with a certain rotation angle are arranged linearly in a radial direction and record thereon position information of the respective regions in the radial direction.

It is to be noted that although FIG. 1C illustrates the stripe patterns as pattern data as if they are arranged in parallel, this is a schematic illustration for illustrating stripe patterns of a considerably short region. Actually, a stripe pattern corresponding with a certain rotation angle is arranged radially in such a manner that an interval between stripe patterns becomes large as approaching the outer periphery of the optical disc 101. As illustrated in FIG. 1B, the stripe pattern is a defect in the visible information recording layer 207. Since the reflection layer 206 is provided under the visible information recording layer 207, a portion corresponding to the stripe pattern which is the defect of the visible information recording layer 207 has a reflectivity higher than that of the visible information recording layer 207.

As illustrated in FIG. 2, the optical disc recording/reproducing device 112 capable of accessing the digital information recording plane 203 of the optical disc 101 to read/write digital information has the optical pickup 102 for accessing the optical disc 101 set to the spindle motor 106 and rotationally driven to perform recording or reproduction.

This typical optical pickup 102 includes a semiconductor laser diode 113 for emitting a laser beam required for reading or writing, a focus driving system 115 for allowing an objective lens 114 to move by means of a focus actuator coil so as to focus the laser beam emitted from the semiconductor laser diode 113 on the digital information recording plane 203 or the visible information recording plane 202 of the optical disc 101, a tracking driving system 116 for performing fine adjustments while allowing the objective lens 114 to move by means of a tracking actuator coil so as to trace a pit formed on the recording layer 205 in aspiral shape, and a photosensor 117 for detecting light reflected from the digital information recording plane 202.

The optical pickup 102 can change a position thereof by a traverse driving circuit 105 for performing traverse control of the optical pickup 102 in the radial direction of the optical disc 101 with the use of a direct-current motor 118 as a power supply.

Specifically, an output reproduction signal from the photosensor 117 is subjected to processing in a reproduction signal processing circuit 108 where various servo error signals and reproduction signals (RF) are generated. These signals are transmitted to a signal processing circuit 109. Of the various error signals, a focus error signal is subjected to processing in the signal processing circuit 109 where a focus driving signal is generated. With this focus driving signal, a focus driving circuit. 103 drives the focus driving system 115; thus, focus control is performed.

A reference numeral 107 denotes a spindle driver of the spindle motor 106 for rotating the optical disc 101. This typical spindle driver 107 controls rotation of the spindle motor 106 on the basis of an output from a Hall element provided in the spindle motor 106. The spindle driver 107 includes an FG signal output for out putting a pulse to each region obtained by processing the output of the Hall element and dividing one rotation into N. On the basis of this FG signal, the spindle driver 107 detects a rotation angle for each region obtained by dividing one rotation into N, and controls a rotation frequency so as to correspond with a certain rotation frequency while monitoring the rotation frequency with the use of the signal processing circuit 109. A radius directional position of the laser beam emitted from the optical pickup 102 is controlled by the traverse driving circuit 105 for driving the entire optical pickup 102 in the radius direction and a tracking driving circuit 104 for driving the objective lens 114 in the radius direction of the optical disc 101 through the tracking driving system 116 to control a minute radius position. At the time of reproducing information from the digital information recording plane 203, since the information track formed on the digital information recording plane 203 is allowed to follow the laser beam to thereby reproduce the information, the signal processing circuit 109 controls the tracking driving circuit 104 with the use of a tracking error signal generated from the reproduction signal by the reproduction signal processing circuit 108 to thereby perform control of the minute position of the laser beam in the radius direction and, also, controls the traverse driving circuit 105totherebyperform control of the movement of the entire optical pickup 102 in the radius direction.

The CPU 110 performs control and adjustment for the reproduction signal processing circuit 108 and the signal processing circuit 109, and performs various kinds of control for the optical disc recording/reproducing device 112. A reference numeral 111 denotes a host computer for storing visible image information to be recorded on the visible information recording plane 202, sequentially transmitting the visible image information to the optical disc recording/reproducing device 112, and allowing the optical disc recording/reproducing device 112 to record the visible image information as follows.

In the case of writing of the visible information, the optical disc 101 is set to the spindle motor 106 so that the visible information recording plane 202 faces the optical pickup 102. In this state, the optical disc recording/reproducing device 112 detects radius position information and rotation position information of the optical disc 101, and specifies an existing position of the optical pickup on the visible information recording plane.

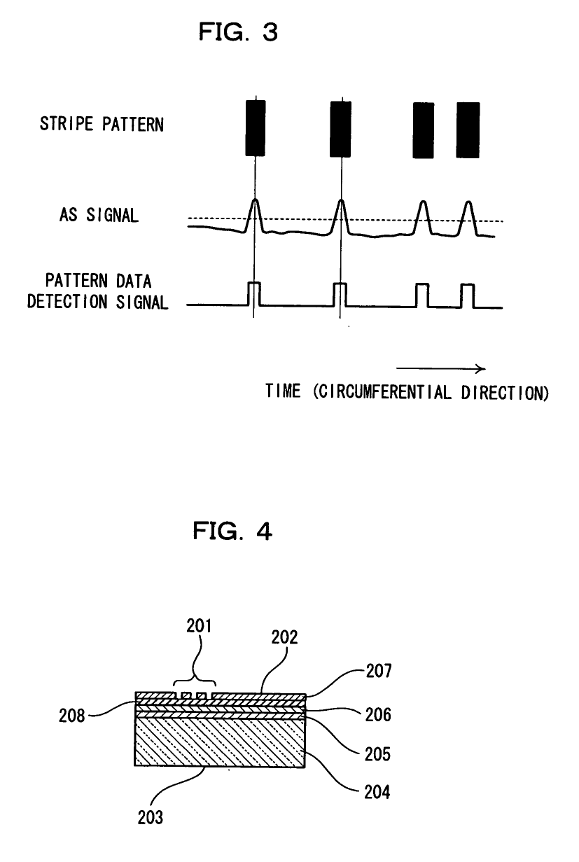

Specifically, when the radius position information recording part 201 of the visible information recording plane 202 passes the reading position of the optical pickup 102 in the reproduction state, the optical pickup 102 reads the stripe pattern recorded in FIG. 3 in accordance with the radius position of the passed optical disc 101.

Herein, FIG. 3 illustrates the filled-in stripe pattern for the sake of convenience. As described above, in the example of this embodiment, the defect of the visible information recording layer 207 is provided in the peripheral portion of the visible information recording layer 207 and the reflection layer 206 provided under the visible information recording layer 207 is exposed therefrom; thus, a high reflectivity is achieved.

FIG. 3 illustrates a waveform of an AS signal upon passage of the radius position information recording part 201. In the optical disc recording/reproducing device, generally, a photo reception portion of the photosensor 117 is divided into four. The AS signal is a summation signal of output signals from the divided four photo reception portions. Since a voltage is output in proportion to the reflectivity, the AS signal exhibits high voltage upon passage of the stripe pattern.

FIG. 3 also illustrates a pattern data detection signal obtained by slicing and binarizing the AS signal at a certain voltage level. Normally, the AS signal is generated by the reproduction signal processing circuit 108 illustrated in FIG. 2. On the other hand, the pattern data detection signal is generated by the reproduction signal processing circuit 108 and, then, is transmitted to the signal processing circuit 109. Alternatively, the pattern data detection signal is generated in the signal processing circuit 109 on the basis of the AS signal transmitted to the signal processing circuit 109.

Then, the generated pattern data detection signal is decoded by the signal processing circuit 109 to create radius position information; thus, it is possible to obtain radius position information on the visible information recording plane 202 having no track. In this embodiment, the reproduction signal processing circuit 108 and signal processing circuit 109 for processing the output signal from the photosensor 117 of the optical pickup 102 configure a radius position information detection section for reading the radius position information recording part 201 with the use of the optical pickup 102 to detect the existing position of the optical disc at the radius position.

The rotation position information of the optical disc 101 is obtained for each region obtained by dividing one rotation into N with the use of an FG pulse signal output from the spindle driver 107 as a rotation angle detection section. In the case of control at a certain rotation frequency, more precise rotation position information is obtained by provision of a precise rotation angle detection section (not illustrated) for dividing an interval between pulses in a time division manner by a required resolution on the basis of the rotation position information obtained by the rotation angle detection section. On the basis of absolute rotation position information of the rotation position, an absolute rotation position can be determined in reference to a count start point by continuously monitoring an FG pulse at all times. Alternatively, the absolute rotation position information maybe obtained in reference to the rotation position at which the aforementioned radius position information is detected.

With the radius position information and rotation position information obtained as described above, the visible information recording plane 202 of the optical disc 101 is divided into fan-shaped regions each having position information allocated thereto.

Next, description will be given of a visible image recording operation performed by the optical disc recording/reproducing device 112.

The CPU 110 temporarily stores image data transmitted from the host computer 111 therein or in a buffer memory (not illustrated) in the signal processing circuit. After completion of the reception of all image data or at the time of receiving a preset amount of image data, the CPU 110 starts to perform recording of visible images. If not, the CPU 110 continuously receives image data from the host computer 111 even during the recording of visible images.

The CPU 11O issues a command to the signal processing circuit 109, controls the spindle driver 107, activates the spindle motor 106, rotates the spindle motor at a constant angular velocity (CAV), and allows the optical pickup 102 to move to a radius position of coordinates designated by the host computer 111.

Then, the signal processing circuit 109 controls a laser beam power of the semiconductor laser diode 103 of the optical pickup 102 and performs irradiation while appropriately switching between a recording power and a reproducing power to thereby perform recording of visible images, in accordance with image information of the corresponding radius position stored in the buffer memory on the basis of the rotation position information. In this embodiment, the CPU 110 and the signal processing circuit 109 configure a visible information recording control section for reading out data of visible information to be written to the visible information recording layer 207 in accordance with an existing position to write the visible information by controlling the power of a laser beam applied from the optical pickup 102 to the visible information recording layer 207.

In addition, the signal processing circuit 109 writes the visible information by controlling the power of the laser beam applied from the optical pickup 102 to the visible information recording layer 207, with the use of a timing read by the optical pickup 102 as a start point.

As described above, even in the optical disc recording/reproducing device 112 for performing traverse control of the optical pickup 102 in the radial direction of the optical disc 101 with the use of the direct-current motor 118, when the optical disc 101 is set in such a manner that the visible information recording plane 202 serving as a label plane of the optical disc 101 faces the optical pickup 102, the radius position information recording part 201 of the optical disc 101 passes the reading position of the optical pickup 102, so that it is possible to specify an existing position of the optical pickup 102 in the traverse direction. Based on this, a portion with physical change caused by control of the magnitude of the laser beam power and a portion without such physical change are formed on the visible information recording plane 202 of the optical disc 101. Thus, visible images can be recorded on the label plane only by the optical disc recording/reproducing device 112 because of the difference in reflectivity between the portions.

Herein, the radius position information recording part 201 in the visible information recording plane 202 serving as a label plane is formed into a fine linear shape, and an area occupied thereby is very small. Software is constructed for the purpose of automatically controlling the recording start position of the optical disc 101 in the circumferential direction with the use of the host computer 111 or the CPU 110 so as to prevent the position of the radius position information recording part 201 from interrupting reading of the visible images developed on the label plane at the time of recording information on the visible information recording layer 207; thus, more favorable recording result can be expected.

Moreover, an area of a region per the same rotation angle becomes large due to the radius position. Therefore, if a visible image is recorded as it is, the image information expands as approaching the outer periphery; thus, it is necessary to perform correction. As the correcting operation, there are a method, performed by the host computer 111, for transmitting previously corrected visible image information to the optical disc recording/reproducing device 112, and a method, performed by the optical disc recording/reproducing device 112, for performing correction while changing the resolution of rotation position information for each radius position to thereby record visible images. The former method is preferable because the alteration in optical disc recording/reproducing device 112 is small.

In this embodiment, the description is given of, as an example, the case that the visible information recording layer 207 is provided on the reverse plane of the data plane of the CD-ROM disc. However, this embodiment is also applicable to a recordable disc based on CD-R/RW standards.

In the aforementioned embodiment, the description is given of, as an example, the case that the reflection layer 206 is placed under the visible information recording layer 207, the radius position information recording part 201 forms the stripe pattern by the defect of the visible information recording layer 207 and the reflectivity of the portion corresponding to the stripe pattern as the defect of the visible information recording layer 207 is higher than that of the visible information recording layer 207. However, as illustrated in FIG. 4, if a reflection layer 208 having a reflectivity lower than that of the visible information recording layer 207 is formed on the reflection layer 206, the optical disc recording/reproducing device 112 using such a disc is configured to recognize only a stripe pattern as the defect of the visible information recording layer 207, the stripe pattern having a reflectivity lower than that of the visible information recording layer 207, thereby recording visible images on the visible information recording layer 207.

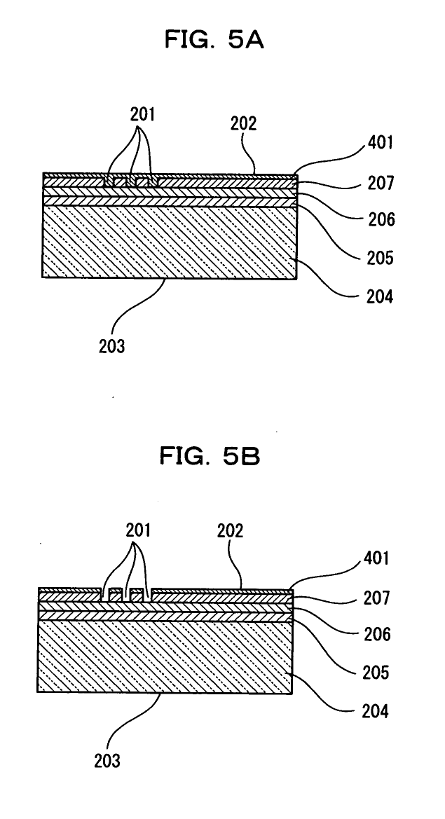

Also in this embodiment, the description is given of, as an example, the case that the visible information recording layer 207 is formed so as to be exposed from the surface of the visible information recording plane 202. However, as illustrated in FIG. 5, the same effect can be achieved also in the case that a transparent thin protective layer 401 is provided on the visible information recording layer 207. More specifically, as illustrated in FIG. 5A, the protective layer 401 may be formed so as to be filled in the defect portion of the visible information recording layer 207 on which pattern data is formed. Alternatively, as illustrated in FIG. 5B, the defect portion may be formed so as to remove the visible information recording layer 207 together with the protective layer 401.

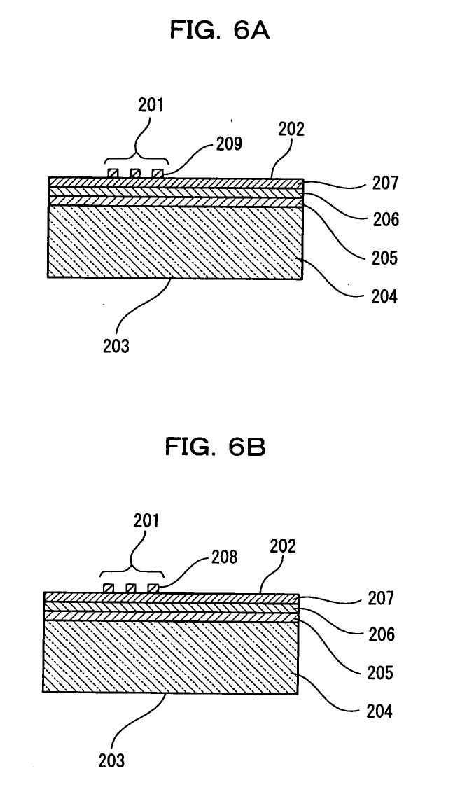

In the radius position information recording part 201 according to each of the aforementioned embodiments, the reflection layer 206 or the reflection layer 208 having a reflectivity lower than that of the visible information recording layer 207 in addition to the reflection layer 206 is formed under the visible information recording layer 207, so that the stripe pattern of the radius position information is formed. However, as illustrated in FIG. 6A, if a reflection layer 209 having a reflectivity higher than that of the visible information recording layer 207 is formed on the visible information recording layer 207, the optical disc recording/reproducing device 112 using such a disc is configured to recognize a stripe pattern having a reflectivity higher than that of the visible information recording layer 207, thereby recording visible images on the visible information recording layer 207.

In the radius position information recording part 201 according to each of the aforementioned embodiments, the reflection layer 206 or the reflection layer 208 having a reflectivity lower than that of the visible information recording layer 207 in addition to the reflection layer 206 is formed under the visible information recording layer 207; thus, the stripe pattern of the radius position information is formed. However, as illustrated in FIG. 6B, if the reflection layer 208 having a reflectivity lower than that of the visible information recording layer 207 is formed on the visible information recording layer 207, the optical disc recording/reproducing device 112 using such a disc is configured to recognize a stripe pattern having a reflectivity lower than that of the visible information recording layer 207, thereby recording visible images on the visible information recording layer 207.

### EMBODIMENT 2

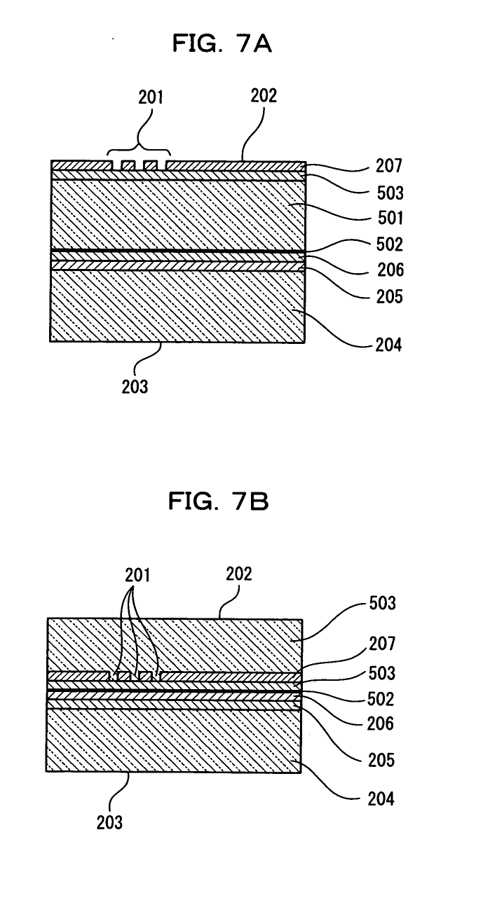

FIG. 7 illustrates Embodiment 2. In Embodiment 1, the description is given of, as an example, the case that visible information is recorded on the disc based on CD standards. However, Embodiment 1 is applicable to discs based on DVD standards, such as a DVD-ROM/R/RW, a DVD+R/RW, and a DVD-RAM.

Specifically, a disc based on DVD standards is a double sided disc. Therefore, as illustrated in FIG. 7A, such a disc can be realized in such a manner that a reflection layer 503 and a visible information recording layer 207 are formed on a reverse plane of a digital information recording plane 203 of a dummy disc 501. Of course, such a disc can be configured in such a manner that the protective layer 401 is provided on the visible information recording layer 207 as described above.

Alternatively, as illustrated in FIG. 7B, the same effect can be achieved in such a manner that a reflection layer 502 and a visible information layer 207 are formed inside a base member on the dummy disc side at a position similar to that of the digital information recording plane 203.

In each of the aforementioned embodiments, the description is given of, as an example, the case that the reflection layer 206 or 503 having a reflectivity higher than that of the visible information recording layer 207 is formed under the visible information recording layer 207. Similarly, the same effect can be achieved as follows: a low reflection layer having a reflectivity lower than that of the visible information recording layer 207 is provided on the reflection layer 206, and a stripe pattern as radius position information is recorded in such a manner that a defect portion of the visible information recording layer 207 in the radius position information recording part 201 is made to have a reflectivity lower than that of the visible information recording layer 207. The optical disc recording/reproducing device 112 using such a disc is configured to recognize the stripe pattern as the defect of the visible information recording layer 207, the stripe pattern having a reflectivity lower than that of the visible information recording layer 207, thereby recording visible images on the visible information recording layer 207.

In this embodiment, the description is given of, as an example, the case that the reflection layer 502 is provided under the visible information recording layer 207 and radius position information is formed by the defect of the visible information recording layer 207. Similarly, the same effect can be achieved in such a manner that a region having a reflectivity higher or lower than that of the visible information recording layer 207 is formed on the visible information recording layer 207.

### EMBODIMENT 3

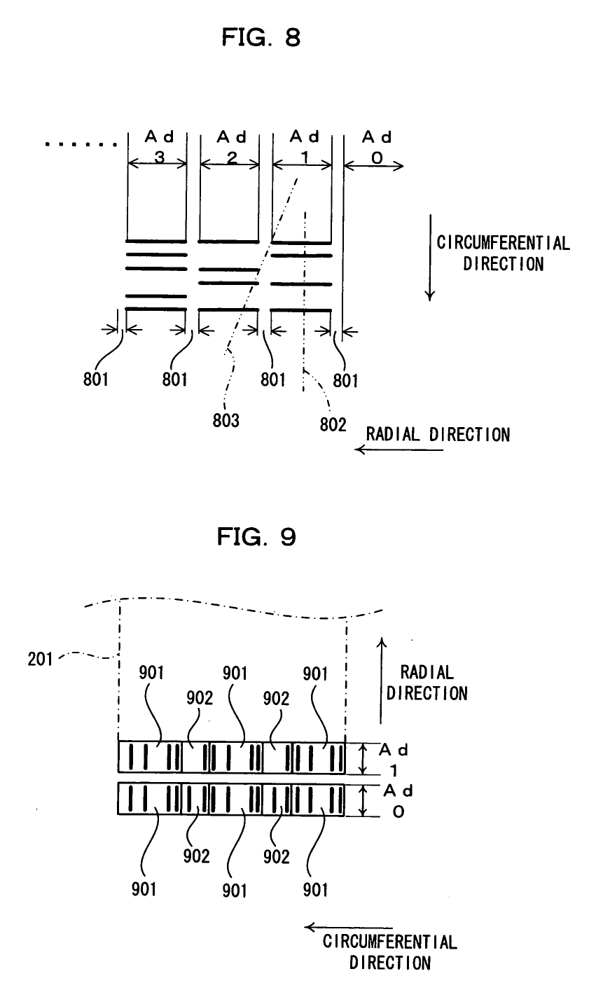

FIG. 8 illustrates a main part of an optical disc according to Embodiment 3 of the present invention. The optical disc is different from that illustrated in FIG. 1 in a pattern of radius position information in the radius position information recording part 201. The other configurations of the optical disc are the same as that according to Embodiment 1.

Specifically, in FIG. 1C, the “0th region Ad0”, the “first region Ad1”, the “second region Ad2”, the “third region Ad3”, . . . are provided without clearance in the radius direction of the optical disc. In FIG. 2, the optical disc has a radius position information division region 801 provided between pieces of radius position information adjacent to each other in the radius direction of the radius position information recording part 201 to distinguish the radius position information on the inner peripheral side from the radius position information on the outer peripheral side. Herein, a region having no radius position information is formed between an arcuate stripe pattern on the inner peripheral side and an arcuate stripe pattern on the outer peripheral side to thereby configure the radius position information division region 801.

With this configuration, if the optical disc 101 has no bending such as warpage, as indicated with a locus 802 shown by a phantom line, the optical pickup 102 traces each region every time the optical disc rotates once to normally read radius position information, thereby determining a radius position. However, if the optical disc 101 has bending such as warpage, as indicated with a locus 803, the optical pickup 102 disadvantageously traces across adjacent regions.

In the case of the stripe pattern illustrated in FIG. 1C, there is a possibility of erroneous determination of the radius position. However, in the case of the stripe pattern according to Embodiment 3, if the optical pickup 102 traces across the adjacent regions, the optical pickup 102 reads the radius position information division region 801 in midstream. Therefore, an interval of the radius position information division region 801, and the like are set in accordance with a minimum interval of the pattern data, so that it is possible to eliminate erroneous determination of the radius position. As illustrated in FIG. 8, if the optical pickup 102 traces across the “first region Ad1” and the “second region Ad2”, the optical disc recording/reproducing device is configured to perform correction of the radius position to record visible information, thereby favorably recording images on the visible information recording layer 207.

In the optical disc recording/reproducing device 112 for treating the optical disc 101 having the radius position information division region 801 formed therein, a radius position information division region passage detection section for detecting passage of the radius position information division region 801 on the basis of contents read by the optical pickup 102 is configured inside the signal processing circuit 109.

The CPU 110 and the signal processing circuit 109 configure a radius position information detection section for detecting an existing position of the optical pickup 102 at the radius position of the optical disc 101 from contents read by the optical pickup 102 which does not pass the radius position information division region 801 and a visible information recording control section for reading out data of visible information to be written to the visible information recording layer 207 in accordance with the detected existing position and controlling the power of a laser beam applied from the optical pickup 102 to the visible information recording layer 207 to thereby write the visible information to the visible information recording layer 207.

As a specific example of the radius position information division region 801, in the case that the reflection layer 206 having a reflectivity higher than that of the visible information recording layer 207 is provided under the visible information recording layer 207 as illustrated in FIG. 1B and the stripe pattern of the radius position information is recorded by the defect of the visible information recording layer 207, the radius position information division region 801 can be formed by the defect of the visible information recording layer 207.

Also in the case that the low refection layer 208 having a reflectivity lower than that of the visible information recording layer 207 is provided under the visible information recording layer 297 and on the reflection layer 206 as illustrated in FIG. 4 and the stripe pattern of the radius position information is recorded by the defect of the visible information recording layer 207, the radius position information division region 801 can be formed by the defect of the visible information recording layer 207.

Further, in the case that the reflection layer 209 having a reflectivity higher than that of the visible information recording layer 207 is provided on the visible information recording layer 207 as illustrated FIG. 6A and the stripe pattern of the radius position information is recorded, the radius position information division region 801 can be formed by the reflection layer 209.

Moreover, in the case that the reflection layer 208 having a reflectivity lower than that of the visible information recording layer 207 is provided on the visible information recording layer 207 as illustrated FIG. 6B and the stripe pattern of the radius position information is recorded, the radius position information division region 801 can be formed by the reflection layer 208.

### EMBODIMENT 4

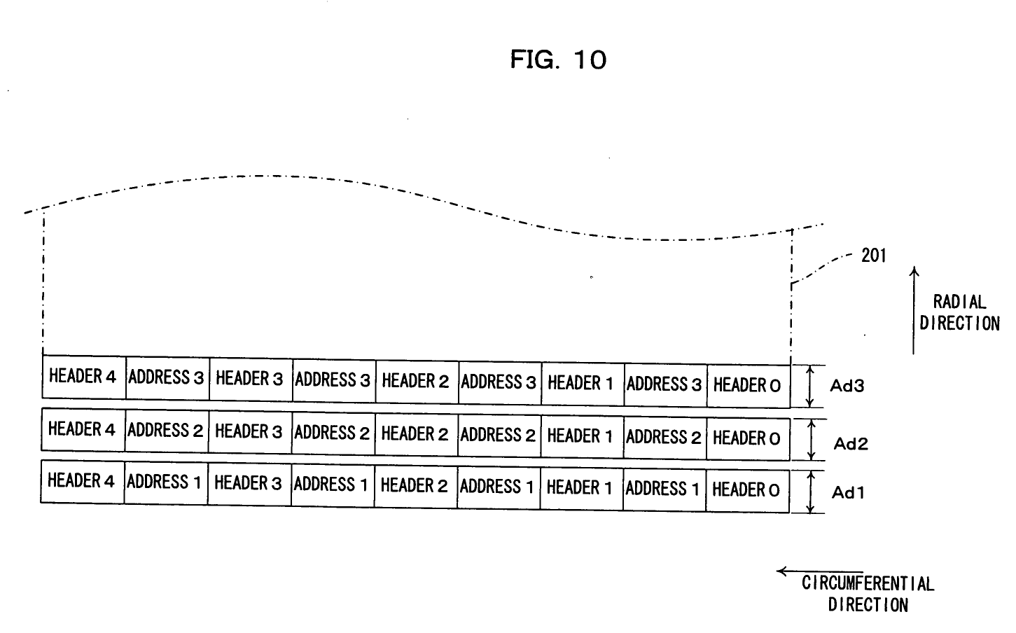

FIGS. 9 and 10 illustrate Embodiment 4 of the present invention and, also, illustrate a specific example of data of the radius position information recording part 201 of the optical disc 101.

As illustrated in FIG. 9, the stripe pattern in each region of the radius position information recording part 201 includes headers 901 with fixed length and fixed pattern and radius position information main bodies 902 with fixed length. Herein, the headers 901 and the radius position information main bodies 902 are alternately and sequentially recorded plural times in such a manner that the radius position information main body 902 is interposed between the headers 901. More specifically, as illustrated in FIG. 10, position information of the first region Ad1 is recorded in such a manner that the radius position information main body 902 of “000001” is interposed between the headers 901 of “101011” in a fore-to-aft direction.

With this configuration, when the reading position of the optical pickup 102 passes the radius position information recording part 201 of the optical disc 101, the optical pickup 102 reads a radius position information main body 902 interposed between effective headers 901 and regards the radius position information main body 902 as effective radius position information in the case that the optical disc 101 has no eccentricity due to warpage or the like. Thus, the optical pickup 102 can perform radius position control to thereby record visible information on the visible information layer 107.

If the optical disc 101 is eccentric due to decentering of a disc hole, decentering of a turn table and an attachment state of a disc to a turn table so that traverse between pieces of radius position information occurs, radius position information interposed between effective headers 901 is not allowed to have a normal data length. As a result, the optical pickup 102 cannot read a radius position information main body 902. In this case, the CPU 110 detects the position of the radius position information main body 902 that cannot be read from the entire radius position information, allows the tracking driving circuit 104 and the traverse driving circuit 105 to operate, and correct the radius position, thereby avoiding erroneous recording of visible information on the radius position.

Description will be given by way of specific examples.

For example, as illustrated in FIG. 10, “address 1”, “address 2”, “address 3”, . . . for radius position information are sequentially arranged in the first region Ad1, the second region Ad2, the third region Ad3, . . . from the inner periphery toward the outer periphery of the optical disc 101 as the radius position information of the radius position information recording part 201. It is assumed herein that the radius position information interposed between pieces of header information is repeatedly recorded four times on the radius position information recording part. The headers are numbered for the sake of description; however, actual stripe patterns of the headers are identical to each other because they have a fixed length and a fixed pattern as described above.

It is herein assumed that visible information is recorded on the first region Ad1 designated by “address 1” in the visible information recording layer 207 and, then, visible information is recorded on the second region Ad2 designated by “address 2”. If the optical disc 101 has no eccentricity or the like and a laser beam from the optical pickup 102 passes near the center of the second region Ad2, pieces of data are detected in the following order:
“header 0”, “address 2”, “header 1”, “address 2”, “header 2”, “address 2”, “header 3”, “address 2”, “header 4”.

However, if the optical beam passes the radius position information division region due to eccentricity or the like, pieces of data are detected as in the following example 1:

### EXAMPLE 1

“header 0”, “address 2”, “header 1”, “address 2”, “header 2”, “address 2”, “improper data”, “address 3”, “header 4”.

In this example, the optical beampasses the radius position information division region 801 at the position of the “header 3”, so that the stripe pattern of “header 3” is different from anormal header pattern. Therefore, it is impossible to normally detect header data. However, since final “header 4” can be detected, “address 3” is detectable.

This case includes a case of constituting a visible information recording processing routine in the CPU 110 for determining that the optical beam passes across “address 2” and “address 3” but close to “address 2” and recording visible image information to be written to the second region Ad2 of “address 2” as it is, a case of constituting a visible information recording processing routine in the CPU 110 for applying a voltage to the tracking driving system 116 in the inner peripheral direction, slightly shifting the optical pickup 102 toward “address 2”, and recording visible image information to be written to the second region Ad2 of “address 2” at the time point of obtainment of stripe patterns “header 0”, “address 2”, “header 1”, “address 2”, “header 2”, “address 2”, “header 3”, “address 2” and “header 4” passing near the center of “address 2”, and a case of constituting a visible information recording processing routine in the CPU 110 for presetting a specified voltage that allows the tracking driving system 116 to move the laser beam from the optical pickup 102 in the inner peripheral direction, applying the voltage to the tracking driving system 116, and immediately recording visible image information without reconfirming radius position information. Selection from any of the aforementioned routines may be previously determined on the basis of a desired accuracy of visible information recording in a radius direction and an allowable value of time for visible information recording.

If improper data is detected at a portion near the center in the radius position information like the following example 2:

### EXAMPLE 2

“header 0”, “address 2”, “header 1”, “improper data”, “header 2”, “address 3”, “header 3”, “address 3”, “header 4”,
“header 0”, “address 2”, “header 1”, “address 2”, “improper data”, “address 3”, “header 3”, “address 3”, “header 4”, or
“header 0”, “address 2”, “header 1”, “address 2”, “improper data”, “improper data”, “header 3”, “address 3”, “header 4”, it is considered that the laser beam from the optical pickup 102 passes near an intermediate portion between “address 2” and “address 3”. This case includes a case of constituting a visible information recording processing routine in the CPU 110 for applying a voltage to the tracking driving system 116 in the inner peripheral direction, slightly shifting the position of the laser beam from the optical pickup 102 toward “address 2”, and recording visible image information to be written to the second region Ad2 of “address 2” at the time point of obtainment of stripe patterns “header 0”, “address 2”, “header 1”, “address 2”, “header 2”, “address 2”, “header 3”, “address 2” and “header 4” passing near the center of “address 2”, and a case of constituting a visible information recording processing routine in the CPU 110 for presetting a specified voltage, applying the voltage to the tracking driving system 116, and immediately recording visible image information without reconfirming radius position information. As in the case of the example 1, selection from any of the aforementioned routines may be previously determined on the basis of a desired accuracy of visible information recording in a radius direction and an allowable value of time for visible information recording.

If improper data is detected at an edge in the radius position information recorded plural times like the following example 3:

### EXAMPLE 3

“header 0”, “address 2”, “header 1”, “address 2”, “header 2”, “address 2”, “header 3”, “improper data”, “header 4”, or
“header 0”, “address 2”, “header 1”, “address 2”, “header 2”, “address 2”, “header 3”, “address 2”, “improper data”, it cannot be determined from “address 2” that the laser beam passes close to either an inner periphery (“address 1”) or an outer periphery (“address 3”). This case includes a case of constituting a visible information recording processing routine in the CPU 110 for determining that the laser beam passes on the edge of “address 2” and recording visible image information to be written to “address 2” as it is, and a case of constituting a visible information recording processing routine in the CPU 110 for applying a voltage to the tracking driving system 116 in the inner peripheral direction or the outer peripheral direction, slightly shifting the tracking driving system 116 toward the inner periphery or the outer periphery, detecting the stripe patterns again to obtain detection patterns like the example 1 or 2 and, then, executing the same processing. As in the case of the example 1, selection fromany of the aforementioned routines may be previously determined on the basis of a desired accuracy of visible information recording in a radius direction and an allowable value of time for visible information recording.

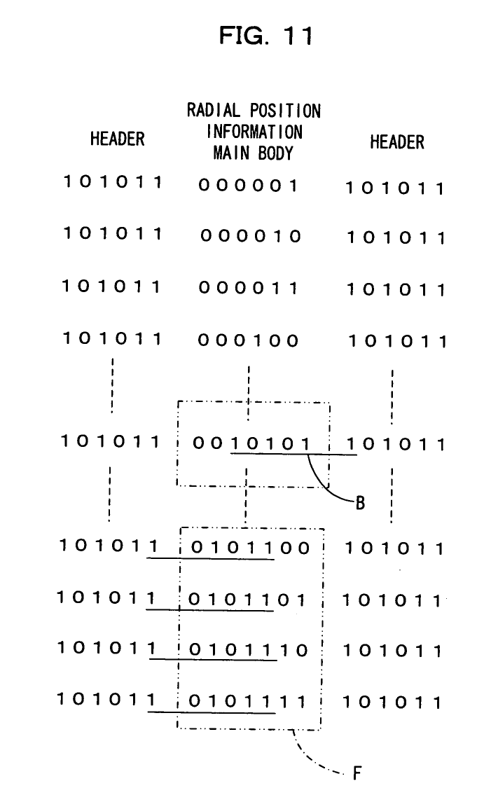

The stripe patterns as the radius position information main bodies of the optical disc 101 are predetermined so as not to correspond with header information when the stripe patterns are connected to the front and rear portions of the header 901 with fixed length and fixed pattern. More specifically, as illustrated in FIG. 11, in the case of using a header of “101011”, a code corresponding with the header is generated as shown by an under line B at a position where the radius position information main body is “0010101”. Therefore, upon manufacturing, the optical disc 101 is configured without the radius position information main body of “0010101”. The optical disc recording/reproducing device 112 for writing visible information to the visible information recording layer 207 of the optical disc 101 configured without the radius position information main body of “0010101” is configured to skip “0010101” and recognize the radius position. In addition, the stripe pattern corresponds with the header also at a position indicated by a rectangle F in FIG. 11. Therefore, such a position is also not provided with the stripe pattern of the radius position information.

In addition, the optical disc 101 must be manufactured in such a manner that the stripe patterns of the radius position information main bodies are shorter in length than the headers with fixed length and fixed pattern and headers with fixed length and fixed pattern are selected such that no stripe patterns of the radius position information main bodies correspond with header information with fixed length and fixed pattern when the stripe patterns of the radius position information main bodies are connected to the front and rear portions of the header with fixed length and fixed pattern.

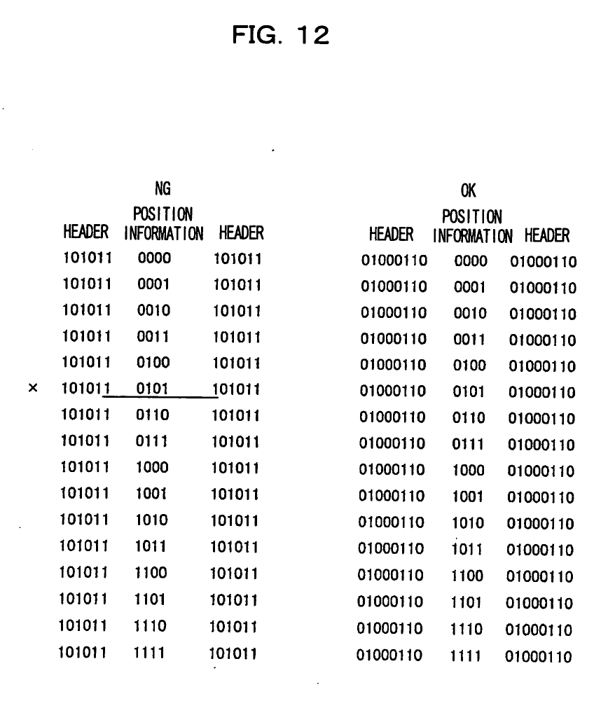

More specifically, in the case of using a header of “101011” as illustrated in a left table of FIG. 12, correspondence with the header occurs when a stripe pattern of a radius position information main body is “0101”. Therefore, the optical disc 101 must be manufactured to select a header with fixed length and fixed pattern and use, for example, a header of “01000110” as illustrated in a right table of FIG. 12.

Herein, the signal processing circuit 109 configures a header detection section for detecting a header with fixed length and fixed pattern from an output of read radius position information. Moreover, the CPU 110 and the signal processing circuit 109 configure a radius position information division region passage detection section for detecting passage of the radius position information division region on the basis of whether or not a data length of a stripe pattern interposed between the headers corresponds with a data length of the radius position information main body with fixed length, from the result of detection by the header detection section and the read radius position information.

### EMBODIMENT 5

It is possible to enhance a radius position accuracy of visible images by applying the aforementioned examples 1 to 3 and detecting further specific position information on the radius position information for detecting the same address information.

For example, the signal processing circuit 109 illustrated in FIG. 2 configures a radius position information division region passage detection section for detecting traverse of the radius position information division region 801. It is possible to record visible images at higher density in a radius direction if visible image information corresponding to a radius address position is recorded sequentially, e.g., it is considered that the laser beam from the optical pickup 102 is positioned near the intermediate portion of “address 2” upon detection of “header 0”, “address 2”, “header 1”, “address 2”, “header 3”, “address 2”, “header 4”, the laser beam from the optical pickup 102 is positioned at an intermediate portion between “address 2” and “address 3” upon detection of the example 2: “header 0”, “address 2”, “header 1”, “improper data”, “header 2”, “address 3”, “header 3”, “address 3”, “header 4” or “header 0”, “address 2”, “header 1”, “address 2”, “improper data”, “address 3”, “header 3”, “address 3”, “header 4” or “header 0”, “address 2”, “header 1”, “address 2”, “improper data”, “improper data”, “header 3”, “address 3”, “header 4”, or the laser beam from the optical pickup 102 is positioned at the center of “address 3” upon detection of “header 0”, “address 3”, “header 1”, “address 3”, “header 2”, “address 3”, “header 3”, “address 3”, “header 4”.

Also in this case, any of a case of repeating detection of address information while slightly shifting a radius position until address position information to be recorded is obtained and a case of applying a specified voltage according to a deviation amount to a tracking coil and, then, immediately recording visible image information without detecting address information can be effected if address information different from an address position to be recorded is detected.

### INDUSTRIAL APPLICABILITY

The present invention is effective in an optical disc, an optical disc recording/reproducing device, anda visible image recording radius position control method of the optical disc recording/reproducing device, capable of specifying a radius and a circumferential position to record desired visible images without adding special hardware, upon recording visible images on a visible information recording layer having no spiral or concentric track, like a normal optical disc.

1. An optical disc having a digital information recording plane for recording or reproducing digital information thereon or therefrom, the optical disc comprising:
a visible information recording layer that is formed on a reverse plane of a digital information recording plane, and can record visible information by a change in physical structure with irradiation of light from an optical pickup; and
a radius position information recording part that is formed on a reverse plane of the digital information recording plane by dividing the optical disc into certain regions at a radius position, and records different radius position information on each divided certain region at the radius position with a reflectivity different from that of the visible information recording layer.

2. The optical disc according to claim 1, wherein the radius position information recording part is a combination of stripe patterns each comprised of radial stripes arranged linearly in a radius direction for a certain rotation angle, each stripe pattern being at one site per one rotation of the optical disc.

3. An optical disc having an information recording plane for recording or reproducing information thereon or therefrom, the optical disc comprising:
a visible information recording layer that is formed on a reverse plane of an information recording plane, and records visible information by a change in physical structure with irradiation of light from an optical pickup;
a radius position information recording part that is formed on the reverse plane of the information recording plane by dividing the optical disc into certain regions at a radius position, and records different radius position information on each divided certain region with a reflectivity different from that of the visible information recording layer; and
a radius position information division region that is provided between two pieces of radius position information adjacent to each other in a radius direction of the radius position information recording part to distinguish the radius position information on an inner peripheral side from the radius position information on an outer peripheral side.

4. The optical disc according to claim 1, further comprising a reflection layer that is provided under the visible information recording layer and has a reflectivity higher than that of the visible information recording layer, wherein a stripe pattern of the radius position information recording part is formed by a defect of the visible information recording layer.

5. The optical disc according to claim 1, further comprising a low reflection layer that is provided under the visible information recording layer and has a reflectivity lower than that of the visible information recording layer, wherein a stripe pattern of the radius position information recording region is formed by a defect of the visible information recording layer.

6. The optical disc according to claim 1, wherein a stripe pattern of the radius position information recording region is formed by a region having a high reflectivity and formed on the visible information recording layer.

7. The optical disc according to claim 1, wherein a stripe pattern of the radius position information recording region is formed by a region having a low reflectivity and formed on the visible information recording layer.

8. The optical disc according to claim 3, further comprising a reflection layer that is provided under the visible information recording layer and has a reflectivity higher than that of the visible information recording layer, wherein the radius position information division region is formed by a defect of the visible information recording layer.

9. The optical disc according to claim 3, further comprising a low reflection layer that is provided under the visible information recording layer and has a reflectivity lower than that of the visible information recording layer, wherein the radius position information division region is formed by a defect of the visible information recording layer.

10. The optical disc according to claim 3, wherein the radius position information division region is formed by a region having a high reflectivity and formed on the visible information recording layer.

11. The optical disc according to claim 3, wherein the radius position information division region is formed by a region having a low reflectivity and formed on the visible information recording layer.

12. The optical disc according to claim 3, wherein the radius position information division region is formed by a region having no stripe pattern.

13. An optical disc as an information disc having an information layer for recording or reproducing information on or from an information track, the information disc comprising, on a reverse plane of the information plane thereof:
a visible information recording layer that can record visible information by a change in physical structure with irradiation of light at a certain level or more; and
a radius position information recording part that divides the information disc into certain ranges at a radius position, and previously records different radius position information on each divided certain range at the radius position having a reflectivity different from that of the visible information recording layer by means of a combination of radial stripe patterns each for a certain rotation angle,
the stripe patterns each comprising headers having a fixed pattern of a fixed length and radius position information main bodies having a fixed length, the radius position information main bodies being alternately and sequentially recorded a plurality of times in such a manner that the radius position information main body is interposed between the headers,
wherein the optical disc controls the radius position of the optical pickup to record visible information by reading the information of the radius position information recording region, and avoids erroneous detection upon occurrence of traverse between pieces of radius position information due to eccentricity, by adopting only radius position information of a radius position information main body interposed between pieces of information of effective headers as effective radius position information.

14. The optical disc according to claim 13, wherein the stripe patterns of the radius position information main bodies are modulated so as not to correspond with information on the header having a fixed pattern of a fixed length when the stripe patterns are connected to the front and rear portions of the header.

15. The optical disc according to claim 13, wherein the stripe patterns of the radius position information main bodies are shorter in length than the headers having a fixed pattern of a fixed length, and the headers are selected so that no stripe patterns of the radius position information main bodies correspond with information on the header having a fixed pattern of a fixed length when the stripe patterns of the radius position information main bodies are connected to the front and rear portions of the header.

16. An optical disc recording/reproducing device having a spindle motor to which the optical disc according to claim 1 is set in such a manner that the visible information recording plane faces an optical pickup and writing visible information to the visible information recording layer while moving the optical pickup in a radius direction, the optical disc recording/reproducing device comprising:
a radius position information detection section for reading the radius position information recording part formed on the visible information recording plane of the optical disc by using the optical pickup so as to detect an existing position of the optical disc at the radius position; and
a visible information recording control section for reading out data of visible information to be written to the visible information recording layer in accordance with the detected existing position, and controlling a power of laser beam applied from the optical pickup to the visible information recording layer so as to write visible information.

17. The optical disc recording/reproducing device according to claim 16, wherein the visible information recording control section is configured to control the power of laser beam applied from the optical pickup to the visible information recording layer to write visible information at a timing that the optical pickup reads the radius position information recording part formed on the visible information recording plane of the optical disc as a start point.

18. An optical disc recording/reproducing device having a spindle motor to which the optical disc according to claim 3 is set, wherein a visible information recording plane faces an optical pickup and the optical pickup is moved in a radius direction while writing visible information to the visible information recording layer, the optical disc recording/reproducing device comprising:
a radius position information division region passage detection section for detecting passage of the radius position information division region based on contents read by the optical pickup;
a radius position information detection section for detecting an existing position of the optical pickup at the radius position of the optical disc based on contents obtained when the radius position information division region passage detection section does not pass the radius position information division region; and
a visible information recording control section for reading out data of visible information to be written to the visible information recording layer in accordance with the detected existing position, and controlling the power of laser beam applied from the optical pickup to the visible information recording layer so as to write visible information.

19. An optical disc recording/reproducing device having a spindle motor to which the optical disc according to claim 3 is set, wherein a visible information recording plane faces an optical pickup and the optical pickup is moved in a radius direction while writing visible information to the visible information recording layers, the optical disc recording/reproducing device comprising:
a radius position information division region passage detection section for detecting passage of the radius position information division region based on contents obtained when the optical pickup reads the radius position information recording part;
a radius position information detection section for detecting an existing position of the optical pickup at the radius position of the optical disc based on contents obtained when the radius position information division region passage detection section does not pass the radius position information division region;
a header detection section for detecting a header having a fixed pattern of a fixed length based on an output from the radius position information detection section;
a radius position information detection section for detecting the header having a fixed pattern having a fixed length upon passage of no radius position information division region so as to detect radius position information based on the reading result of the radius position information detection section and the detection result of the radius position information division region passage detection section; and
a visible information recording control section for reading out data of visible information to be written to the visible information recording layer in accordance with the detected existing position, and controlling a power of laser beam applied from the optical pickup to the visible information recording layer so as to write visible information.

20. The optical disc recording/reproducing device according to claim 16, further comprising a precise rotation angle detection section for further dividing the detection information of the rotation angle detection section into equal portions, wherein a detection result of the precise rotation angle detection section is used as rotation angle information for visible image recording control.

21. The optical disc recording/reproducing device according to claim 19, wherein
the radius position information detection section detects, from the stripe patterns sequentially recorded a plurality of times, the stripe pattern of the header having a fixed pattern of a fixed length upon passage of no radius position information division region so as to detect a plurality of pieces of effective radius position information, and further obtains position information in the stripe pattern of the radius position information divided for each of the certain ranges, based on presence/absence of passage of the radius position information division region of the stripe patterns sequentially recorded a plurality of times, the position of passage of the radius position information division region, and the detected plurality of pieces of effective radius position information, respectively from the detection result of the radius position information division region passage detection section, and
the visible information recording control section is configured to record visible image information by controlling intensity of the laser beam from the optical pickup while moving the optical pickup in the radius direction of the optical disc, based on the rotation angle and radius position detection information of the optical disc and the position information in the stripe pattern of the radius position information divided for each of the certain regions on an assumption that a rotation velocity of the optical disc is made constant.

22. An optical disc recording method used when the optical disc according to claim 1 is set to a spindle motor so that a visible information recording plane faces an optical pickup, and visible information is written to a visible information recording layer while an optical pickup is moved in a radius direction, the optical disc recording method comprising:
reading a radius position information recording part formed on the visible information recording plane of the optical disc by means of the optical pickup so as to detect an existing position of the optical disc at a radius position; and
reading out data of visible information to be written to the visible information recording layer in accordance with the detected existing position, and controlling a power of laser beam applied from the optical pickup to the visible information recording layer so as to write the visible information.

23. The optical disc recording method according to claim 22, further comprising controlling the power of laser beam applied from the optical pickup to the visible information recording layer so as to write visible information at a timing that the optical pickup reads the radius position information recording part formed on the visible information recording plane of the optical disc as a start point.

24. An optical disc recording method used when the optical disc according to claim 3 is set to a spindle motor so that the visible information recording plane faces an optical pickup, and visible information is written to the visible information recording layer while the optical pickup is moved in a radius direction, the optical disc recording method comprising:
detecting passage of a radius position information division region based on contents read by the optical pickup, and detecting an existing position of the optical pickup at the radius position of the optical disc based on contents obtained when the radius position information division region is not passed; and
reading out data of visible information to be written to the visible information recording layer in accordance with the detected existing position, and controlling a power of laser beam applied from the optical pickup to the visible information recording layer so as to write visible information.

25. An optical disc recording method used when the optical disc according to claim 13 is set to a spindle motor so that the visible information recording plane faces an optical pickup, and visible information is written to the visible information recording layer while the optical pickup is moved in a radius direction, the optical disc recording method comprising:
detecting whether or not a radius position information division region is passed, based on contents obtained when the optical pickup reads a radius position information recording part;
detecting an existing position of the optical pickup at a radius position of the optical disc, based on contents obtained when the radius position information division region is not passed;
detecting a header having a fixed pattern of a fixed length based on an output from a radius position information detection section;
detecting the header having a fixed pattern of a fixed length obtained when the radius position information division region is not passed so as to detect radius position information, based on a reading result of the radius position information detection section and a detection result of the radius position information division region passage detection section; and
reading out data of visible information to be written to the visible information recording layer in accordance with the detected existing position, and controlling a power of a laser beam applied from the optical pickup to the visible information recording layer so as to write visible information.

26. The optical disc recording method according to claim 22, wherein detection information on a rotation angle detection section is further divided into equal portions and taken as rotation angle information for visible image recording control, in using a detection result of a precise rotation angle detection section.

27. The optical disc recording method according to claim 25, further comprising:
detecting, from stripe patterns sequentially recorded a plurality of times, a stripe pattern of the header having a fixed pattern of a fixed length which has not passed the radius position information division region so as to detect a plurality of pieces of effective radius position information, and further obtaining position information in the stripe patterns of the radius position information divided for each of the certain regions, based on presence/absence of passage of the radius position information division region of the stripe patterns sequentially recorded a plurality of times, the position of passage of the radius position information division region, and the detected plurality of pieces of effective radius position information, respectively from the detection result of the radius position information division region passage detection section, and
recording visible image information by controlling intensity of a laser beam from the optical pickup while moving the optical pickup in the radius direction of the optical disc based on the rotation angle and radius position detection information of the optical disc, and the position information in the stripe pattern of the radius position information divided for each of the certain regions on assumption that a rotation velocity of the optical disc is made constant.
